(19) United States
(12) Patent Application Publication
(10) Pub. No.: US 2010/0205007 A1
(43) Pub. Date: Aug. 12, 2010

(54) Method of Pathologic Correlation for Radiology Resident Education

(76) Inventor: Indu Rekha Meesa, Grand Rapids, MI (US)

Correspondence Address: Indurekha Meesa, 4593 Woodcreek Drive, Grand Rapids, MI, 49546, US

(21) Appl. No.: 12/497,663

(22) Filed: Jul. 4, 2009

Related U.S. Application Data
(60) Provisional application No. 61/150,609, filed on Feb. 6, 2009.

(51) Int. Cl. G06Q 50/00; G06F 17/30

(52) U.S. Cl. 705/3; 705/2; 707/E17.014; 707/E17.044

(57) ABSTRACT

A method and a system for integrating a Radiology Information System (RIS) and hospital electronic medical records system (EMRS) within picture archiving and communications systems (PACS) to promote learner based education includes steps and means for flagging an interesting patient case, being viewed in PACS, for follow-up on diagnoses. Submitting the flagged interesting patient case, wherein the EMRS is queried for diagnoses information for the interesting patient case. Requesting a report for the interesting patient case where at least one diagnoses is available. Requesting feedback on a patient case interpretation, wherein information from PACS workstation and EMRS is sent to consulting physicians for reviewing. Requesting a report generation from the reviewing. Identifying an abnormality in a patient case image using the PACS workstation. Providing information regarding the abnormality. Requesting a differential diagnoses, wherein the information and the differential diagnoses table (DDT) are used to produce the differential diagnoses. Receiving the differential diagnoses.

### CROSS-REFERENCE TO RELATED APPLICATIONS

The present Utility patent application claims priority benefit of the U.S. provisional application for patent Ser. No. 61/150,609 filed on Feb. 6, 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to medical training. More particularly, the invention relates to a method of pathologic correlation for radiology resident education.

### BACKGROUND OF THE INVENTION

Radiology is a very dynamic, rapidly changing, technologically oriented specialty. The field of medicine has come to depend heavily on radiologists' interpretation of images to determine diagnoses and clinical management of patients. It is crucial and necessary that radiologists in training are provided with proper feedback and further instruction about their interpretation of studies.

However, radiologists often have less direct involvement with patients and the physicians involved in the patients' care. Due to conflicts with efficiency and workflow, it becomes difficult for radiologists to discuss interesting cases with other physicians (e.g., pathologists, surgeons, etc.) during a given workday. This makes learning for the radiology resident an especially challenging process.

It is therefore an objective of the present invention to provide a software application system design that uses information technology (IT) to integrate RIS and hospital electronic medical records system (EMRS) within picture archiving and communications systems (PACS) to promote learner based education. Such a design would enable radiology residents to review interesting cases they have interpreted and correlate their findings with the pathology results and discharge diagnoses.

Over the last 20 years computers have become increasingly affordable. With the development of high-capacity physical media for storage of digital information, along with increasing CPU power, it has become very feasible to use computers to store, transmit, and display images of biomedical relevance. Simultaneously, the development of networks has arguably been the single most dramatic recent development in IT, due to their contribution to the fusion of computing and communications.

The development and commercial availability of relational database management systems (RDMS), which allow for storage and retrieval of huge amounts of data and images, is an integral component of IT. First described by E. F. Codd at IBM in 1970, a relational database is a collection of data items organized as a set of formally described tables from which data can be accessed or re-assembled in many different ways without having to reorganize the database tables. The utilization of RDMS, in coordination with the widespread use and accessibility of the Internet has led to a revolution in information dissemination and retrieval.

Development of communications networks, databases, and programming languages led to the development of EMRS and more recently the PACS. PACS was implemented to handle the increasing proportion of digital images generated from new medical imaging modalities. Radiology, due to extensive use of images, is one field in medicine that has significantly benefited from the Internet and other IT innovations. For example, with PACS, radiology education, worldwide consultation, and scientific presentation via the Internet have become a reality because medical images as well as text information can be transported via the Internet.

Currently, the Internet offers a variety of radiological resources that supplement and extend information from current sources such as books and periodicals. Digital teaching files, networked multimedia textbooks, and online continued medical education (CME) credits have become a reality. With the recent developments of PACS and the evolution of standards (e.g., Digital Imaging and Communications in Medicine (DICOM)), the development of a digital teaching files system is facilitated, allowing the radiologist to benefit from the advantages of digital imaging technology to edit and share image collections.

The information technology revolution has dramatically changed the traditional education process. The Internet, powerful databases, and sophisticated software allow for sharing educational information worldwide, making educational materials available to radiology residents 24 hours a day. Such technologies can be used more effectively to develop creative and useful software to further promote the education of radiology residents.

In view of the foregoing, there is a need for improved techniques for using IT to integrate RIS and hospital EMRS within PACS to create a system of digital teaching files for radiology residents.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an exemplary resident interesting case application system, in accordance with an embodiment of the present invention;

FIG. 2 is a flowchart illustrating an exemplary method for obtaining feedback from fellow residents and practicing radiologists, in accordance with an embodiment of the present invention;

FIG. 3 is a flowchart illustrating a process for an exemplary software application to generate differential diagnoses based on a region of interest, in accordance with an embodiment of the present invention; and

FIG. 4 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a method and a system for integrating Radiology Information System (RIS) and a hospital electronic medical records system (EMRS) within Picture archiving and communications systems (PACS) to promote learner based education is presented.

In one embodiment a method for integrating Radiology Information System (RIS) and a hospital electronic medical records system (EMRS) within Picture archiving and communications systems (PACS) to promote learner based education is presented. The method includes steps for flagging an interesting patient case for follow-up on diagnoses, steps for submitting the flagged interesting patient case, steps for requesting a report for the interesting patient case, steps for requesting feedback on a patient case interpretation, steps for requesting a report generation from the feedback, steps for identifying an abnormality in a patient case image, steps for providing information regarding the abnormality, steps for requesting a differential diagnoses and steps for receiving the differential diagnoses.

In another embodiment for integrating Radiology Information System (RIS) and a hospital electronic medical records system (EMRS) within Picture archiving and communications systems (PACS) to promote learner based education is presented. The method includes the steps of flagging an interesting patient case, being viewed at a PACS workstation, for follow-up on diagnoses. Submitting the flagged interesting patient case, wherein the EMRS is queried for diagnoses information for the interesting patient case. Requesting a report for the interesting patient case where at least one diagnoses is available. Requesting feedback on a patient case interpretation, wherein information from Radiology Information System (RIS) and a hospital electronic medical records system (EMRS) within Picture archiving and communications systems (PACS) is sent to consulting physicians for reviewing. Requesting a report generation from the reviewing. Identifying an abnormality in a patient case image using the PACS workstation. Providing information regarding the abnormality. Requesting a differential diagnoses, wherein the information and the differential diagnoses table, (DDT) are used to produce the differential diagnoses. Receiving the differential diagnoses.

In another embodiment for integrating Radiology Information System (RIS) and a hospital electronic medical records system (EMRS) within Picture archiving and communications systems (PACS) to promote learner based education is presented. The system includes means for flagging an interesting patient case, being viewed in PACS, for follow-up on diagnoses and for submitting the flagged interesting patient case, wherein the EMRS is queried for diagnoses information for the interesting patient case. The system further includes means for requesting a report for the interesting patient case where at least one diagnoses is available. The system further includes means for requesting feedback on a patient case interpretation, wherein information from Radiology Information System (RIS) and a hospital electronic medical records system (EMRS) within (PACS) is sent to consulting physicians for reviewing and means for requesting a report generation from the reviewing. The system further includes means for identifying an abnormality in a patient case image using the PACS workstation and for providing information regarding the abnormality. The system further includes means for requesting a differential diagnoses, wherein the information and the EMRS are used to produce the differential diagnoses and means for receiving the differential diagnoses from a pre-populated differential diagnoses table (DDT).

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

During a regular clinical day, radiologists need to work very efficiently and often encounter numerous interesting cases. Due to the hectic work environment, radiologists seldom have the opportunity to confirm their findings after the definitive pathological diagnosis becomes available. However, this process of going back to review an interesting case and correlate their radiological interpretation with pathological diagnoses can be a very reinforcing and educational process.

With this in mind, preferred embodiments of the present invention provide an application system designed for a PACS workstation that promotes resident education. In preferred embodiments the PACS workstation comprises a resident interesting cases database (RICD) designed using the object oriented relational model after taking into consideration all the requirements from the end users such as, but not limited to, education chairs of the radiology department, residency program directors, etc. Using preferred embodiments, radiology residents are able to flag interesting cases for future follow-up, for either pathologic diagnoses or discharge diagnoses, simply by marking a checkbox on the case at the PACS workstation. Obtaining feedback for radiology examination interpretation from fellow residents and practicing radiologists can also be a great learning tool. Preferred embodiments of the present invention also enable residents to obtain feedback for case interpretation from colleagues.

Radiologists and radiology residents must memorize and be able to recall an impressive number of differential diagnoses after identifying the abnormality in any given case. Preferred embodiments of the present invention can be used to aid in the learning process and may be applied in real time to improve the efficiency and accuracy of the examination interpretation by providing a software application to generate differential diagnoses based on a region of interest.

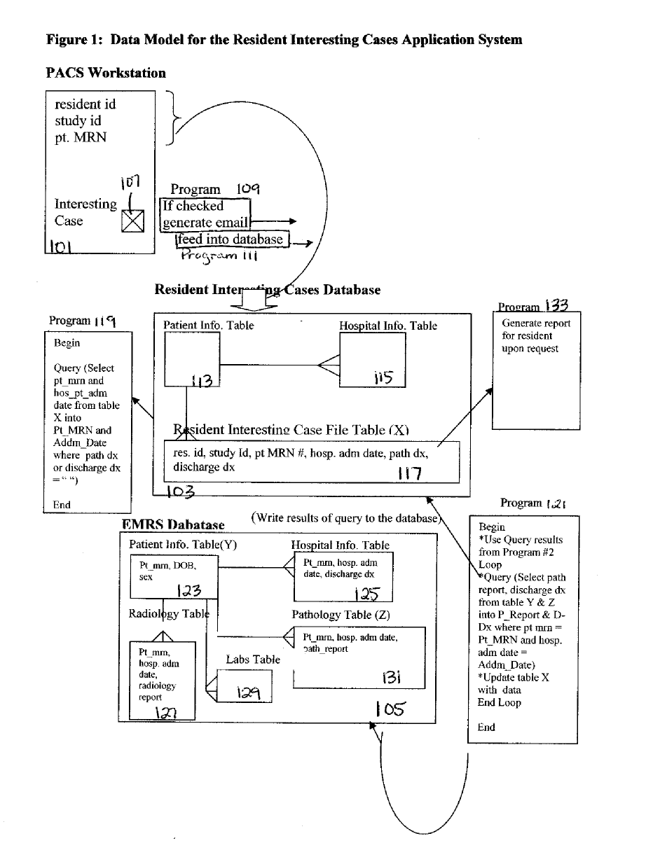

FIG. 1 is a block diagram illustrating an exemplary resident interesting case application system, in accordance with an embodiment of the present invention. In the present embodiment, the resident interesting case application comprises a PACS workstation 101, a RICD 103, an EMRS database 105, and multiple programs for performing various functions. PACS workstation 101 enables a resident to view information pertaining to a patient case such as, but not limited to, patient information, a study ID, the patient medical record number (MRN), any images taken of the patient, etc. If the resident determines that the case he is viewing is interesting, the resident may indicate this in the patient record by checking an interesting case box 107. Once the patient record is closed for a case that has been flagged as interesting, a preparation program 109 that is running in the background prepares the resident and case information including, but not limited to, patient MRN, study ID, interpretation, images, etc. for submission to RICD 103.

In the present embodiment, information is transferred from PACS workstation 101 to RICD 103, which is on another server, via email. An automated email can be generated by preparation program 109 once a study of interest is closed in which the email comprises the information mentioned above in a text format. Those skilled in the art, in light of the present teachings, will readily recognize that a multiplicity of different means may be used to transfer information from the PACS workstation to the RICD such as, but not limited to, DICOM. In the present embodiment, a receiving software program 111 running on the server with RICD 103 upon receiving the email parses out the information, checks the information for accuracy, and writes the data into RICD 103. RICD 103 is a relational database comprising a patient information table 113, a hospital information table 115, and a resident interesting case file table 117. Each record in a relational database must be unique. Therefore, the unique identifier within resident interesting case file table 117 is the resident ID, patient MRN, and PACS workstation generated study ID. Each record in resident interesting case file table 117 comprises the following fields: resident ID, patient MRN, PACS generated study ID, date of admission, indication for study field, clinically relevant patient information (e.g., age, medical history, symptoms), radiology report (i.e., description field), and fields for pathological diagnoses and discharge diagnoses. A query program 119 running every 24 hours interfaces with EMRS database 105 and runs a query on all patient records whose fields for pathological diagnosis or discharge diagnosis are blank in RICD 103. This finds the cases within RICD 103 that do not provide diagnosis or discharge information so this information may be added to the case if available. In alternate embodiments, the query program may run at different intervals for example, without limitation, every 12 hours, weekly, monthly, etc. In the present embodiment, the key identifiers for the query are the patient ID and date of admission from RICD 103. An update program 121 then searches the tables of EMRS database 105 for the information missing from the cases compiled by query program 119. EMRS database 105 comprises a patient information table 123, a hospital information table 125, a radiology table 127, a labs table 129, and a pathology table 131. EMRS is a relational database. The search results of update program 121 are populated to the appropriate database record fields in RICD 103.

Finally, user-friendly reports comprising a list of all the interesting cases are automatically generated for each resident in the training program by a report program 133. These reports are made available to the residents upon sending a request on a PACS workstation. These reports give the resident the option to look up specific cases based on when the study was performed or the radiologic diagnoses. Such an application system enables the residents to gain a better grasp of the subject with minimal interruption of daily workflow. The system reinforces what the residents already know with pathological correlation and also enables the residents to learn from their mistakes. For example, without limitation, if the pathological diagnoses are different from their original interpretation, the resident can go back to the original study, review the pertinent clinical information and learn from it.

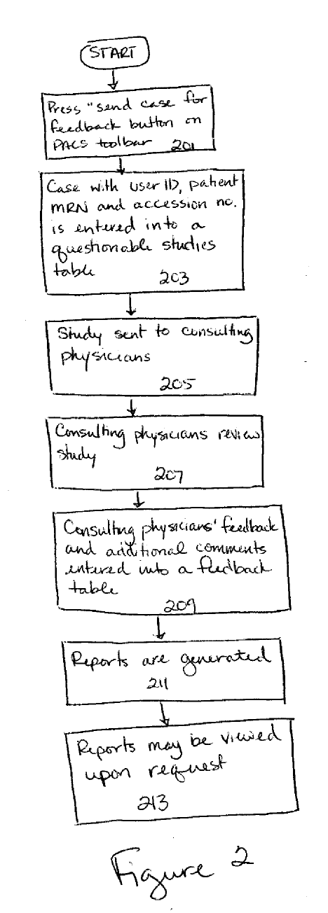

FIG. 2 is a flowchart illustrating an exemplary method for obtaining feedback from fellow residents and practicing radiologists, in accordance with an embodiment of the present invention. This method enables a resident or staff radiologist to forward a study they have interpreted for a second opinion. The user begins by pressing a “Send Case for Feedback” button on the PACS workstation toolbar and selects the physicians he would like to ask for a second opinion in step 201. The system then retrieves the user ID, the patient MRN and the accession number for the case and enters the case into a questionable studies table in step 203. The study is then sent to the queue(s) of the consulting physician(s) in step 205. The consulting physician(s) review the study and either agree or disagree with the original interpretation in step 207. This feedback along with any additional comments is entered into a feedback table in step 209. Reports can then be generated in step 211, and in step 213 these reports are available for review and learning upon request.

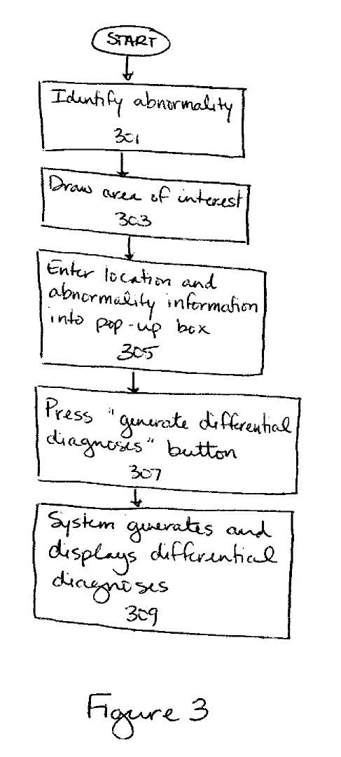

FIG. 3 is a flowchart illustrating the process of an exemplary software application to generate differential diagnoses based on a region of interest, in accordance with an embodiment of the present invention. Each imaging modality is different, and the present embodiment is an application for CT examinations. This application takes user input and generates a list of differential diagnoses. A similar concept can be used in alternate embodiments to create applications for other imaging modalities such as, but not limited to, MRI, Ultrasound, Plain Films, and Nuclear Medicine. With Computed Tomography (CT), lesion characterization is based on density, with Magnetic Resonance Imaging (MRI), lesion characterization is based on sequence and signal characteristics, with ultrasound, lesion characterization is based on the type of acoustic enhancement, Nuclear Medicine is functional imaging and is dependent on preferential uptake of the radiopharmaceutical by different organs. With plain films, lesion characterization is based on opacity/luceny. Therefore, each modality will require a different set of pre-populated values in the differential diagnoses table. So for example, if the ROI is placed on a CT image, after gathering all the necessary information, the program will search in the CT_DDT table to find a match to come up with the differential diagnoses.

Referring to FIG. 3, the process begins in step 301 by identifying the abnormality in the image. Then, in step 303, the radiologist draws an area of interest around the site of interest. The application then displays a pop up box into which the radiologist enters the organ system and location and describes the abnormality (i.e., density, shape, size, calcifications, fat, etc.) in step 305. In step 307 the radiologist presses a “Generate differential diagnosis” button. The system generates and displays differential diagnoses in step 309 by searching a DDT database for differential diagnoses that match the information entered in step 305. The radiologist may then use this information to help finalize their report.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

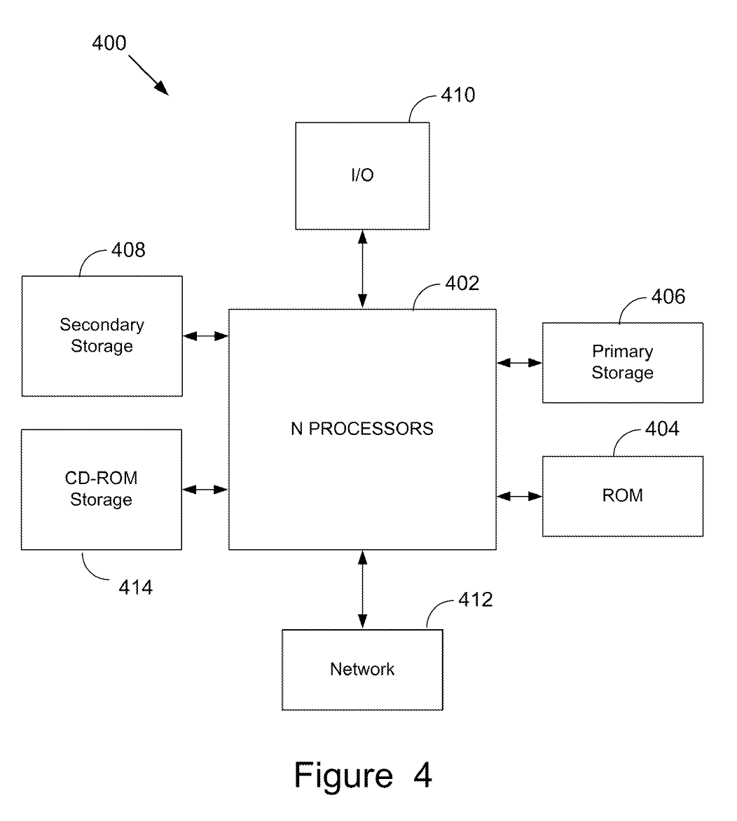

FIG. 4 illustrates a typical computer system that, when appropriately configured or designed, can serve as a computer system in which the invention may be embodied. The computer system 400 includes any number of processors 402 (also referred to as central processing units, or CPUs) that are coupled to storage devices including primary storage 406 (typically a random access memory, or RAM), primary storage 404 (typically a read only memory, or ROM). CPU 402 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 404 acts to transfer data and instructions uni-directionally to the CPU and primary storage 406 is used typically to transfer data and instructions in a bi-directional manner. Both of these primary storage devices may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection as shown generally at 412, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the servers and databases on which the programs and medical records reside and the steps performed by the programs on these servers may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing a system using IT to promote resident education according to the present invention will be apparent to those skilled in the art. The invention has been described above by way of illustration, and the specific embodiments disclosed are not intended to limit the invention to the particular forms disclosed. For example, the particular implementation of the application may vary depending upon the particular type of medical field to which it is applied. The applications described in the foregoing were directed to radiology implementations; however, similar techniques are to apply similar applications to different medical fields such as, but not limited to, emergency medicine, surgery, pathology, etc. Non-radiology implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A method for integrating Radiology Information System (RIS) and a hospital electronic medical records system (EMRS) within PACS to promote learner based education, the method comprising:
steps for flagging an interesting patient case for follow-up on diagnoses;
steps for submitting said flagged interesting patient case;
steps for requesting a report for said interesting patient case;
steps for requesting feedback on a patient case interpretation;
steps for requesting a report generation from said feedback;
steps for identifying an abnormality in a patient case image;
steps for providing information regarding said abnormality;
steps for requesting a differential diagnoses; and
steps for receiving said differential diagnoses.

2. The method as recited in claim 1, further comprising steps for receiving an email comprising said diagnoses information for said interesting patient case.

3. The method as recited in claim 1, further comprising steps for submitting names of consulting physicians for reviewing to provide feedback.

4. The method as recited in claim 1, further comprising steps for providing location of said abnormality in said patient case image.

5. A method for integrating Radiology Information System (RIS) and a hospital electronic medical records system (EMRS) within PACS to promote learner based education, the method comprising the steps of:
flagging an interesting patient case, being viewed in PACS workstation, for follow-up on diagnoses;
submitting said flagged interesting patient case, wherein the EMRS is queried for diagnoses information for said interesting patient case;
requesting a report for said interesting patient case where at least one diagnoses is available;
requesting feedback on a patient case interpretation, wherein information from PACS and EMRS is sent to consulting physicians for reviewing;
requesting a report generation from said reviewing;
identifying an abnormality in a patient case image using the PACS workstation;
providing information regarding said abnormality;
requesting a differential diagnoses, wherein said information and the DDT are used to produce said differential diagnoses; and
receiving said differential diagnoses.

6. The method as recited in claim 5, wherein a cases database stores information for said interesting patient case obtained from RIS and EMRS.

7. The method as recited in claim 5, wherein the EMRS is queried for diagnoses information, for said interesting patient case, at periodic times.

8. The method as recited in claim 7, wherein said diagnoses information is stored in said cases database.

9. The method as recited in claim 8, further comprising the step of receiving an email comprising said diagnoses information for said interesting patient case.

10. The method as recited in claim 5, further comprising the step of submitting names of consulting physicians for said reviewing.

11. The method as recited in claim 5, wherein said feedback is stored in said cases database.

12. The method as recited in claim 5, further comprising the step of providing location of said abnormality in said patient case image.

13. A system for integrating radiology information system (RIS) and a hospital electronic medical records system (EMRS) to promote learner based education, the system comprising:
means for flagging an interesting patient case, being viewed in PACS workstation, for follow-up on diagnoses and for submitting said flagged interesting patient case, wherein the EMRS is queried for diagnoses information for said interesting patient case;
means for requesting a report for said interesting patient case where at least one diagnoses is available;
means for requesting feedback on a patient case interpretation, wherein information from PACS workstation and EMRS is sent to consulting physicians for reviewing;
means for requesting a report generation from said reviewing;
means for identifying an abnormality in a patient case image using the PACS workstation and for providing information regarding said abnormality;
means for requesting a differential diagnoses, wherein said information and the DDT are used to produce said differential diagnoses; and
means for receiving said differential diagnoses.

14. The system as recited in claim 13, further comprising means for storing information for said interesting patient case obtained from PACS workstation and EMRS a cases database.

15. The system as recited in claim 13, further comprising means for querying the EMRS for diagnoses information for said interesting patient case, at periodic times.

16. The system as recited in claim 15, further comprising means for storing said diagnoses information in said cases database.

17. The system as recited in claim 16, further comprising means for sending an email comprising said diagnoses information for said interesting patient case.

18. The system as recited in claim 13, further comprising means for submitting names of consulting physicians for said reviewing.

19. The system as recited in claim 13, further comprising means for storing said feedback in said cases database.

20. The system as recited in claim 13, further comprising means for providing location of said abnormality in said patient case image.
